(19) United States
(12) Patent Application Publication
(10) Pub. No.: US 2025/0117430 A1
(43) Pub. Date: Apr. 10, 2025

(54) TREE-BASED CONTENT GENERATION USING GENERATIVE MODELS

(71) Applicant: Capitol AI, Inc., San Mateo, CA (US)

(72) Inventors: Shaun Modi, Washington, DC (US); Thomas Hallaran, Madison, WI (US); Matthew Stadler, New York, NY (US); Geoffrey Thorpe, Portland, OR (US); Sameer Gupta, New York, NY (US)

(21) Appl. No.: 18/907,167

(22) Filed: Oct. 4, 2024

Related U.S. Application Data
(60) Provisional application No. 63/587,975, filed on Oct. 4, 2023.

(51) Int. Cl. G06F 16/901; G06F 3/04842

(52) U.S. Cl. CPC G06F 16/9027; G06F 3/04842

(57) ABSTRACT

A content generation platform iteratively generates prompts to a generative model to automatically generate rich, detailed content items. The platform receives an instruction, via a user interface, to generate a content item, where the instruction includes a first topic for the content item. The platform performs a search of an information source using at least a portion of the first topic, identifying a first set of additional topics related to the first topic that are output for display by the user interface. A user can select at least one second topic from the first set. The platform generates one or more prompts based on the first topic and the second topic, instructing the generative model to generate the content item based on the first topic and the second topic and to return the generated content item. The content item can be output to the user interface.

### CROSS-REFERENCE TO RELATED APPLICATION

This application claims the benefit of U.S. Provisional Patent Application No. 63/587,975, filed Oct. 4, 2023, which is incorporated herein by reference in its entirety.

### BACKGROUND

Generative models are a class of artificial intelligence (AI) systems designed to generate new data instances that resemble a given dataset. These models are trained on large datasets and learn the underlying patterns and structures within the data. Once trained, generative models can produce new, synthetic data that is statistically similar to the training data. Common types of generative models include Generative Adversarial Networks (GANs), Variational Autoencoders (VAEs), and autoregressive models like GPT (Generative Pre-trained Transformer).

Many generative models produce content based on one or more prompts, where each prompt is an input or set of instructions given to the generative model to guide its output. Crafting a prompt that yields the desired result can be challenging due to the complexity and variability of the model's responses. The effectiveness of a prompt depends on various factors, including the specificity of the instructions, the context provided, and inherent biases in the training data.

### BRIEF DESCRIPTION OF THE DRAWINGS

Detailed descriptions of implementations of the present invention will be described and explained through the use of the accompanying drawings.

FIGS. 1A-1F are schematic diagrams illustrating an example process by which a content generation platform generates a content item, according to some implementations.

FIG. 2 is a block diagram illustrating an architecture of a content generation platform, according to some implementations.

FIG. 3 is a flowchart illustrating a process for iteratively generating prompts for content generation, according to some implementations.

FIGS. 4A-4F illustrate example user interfaces that are output from the content generation platform for display to a user and that facilitate content generation according to some implementations.

FIG. 5 is a block diagram that illustrates an example of a computer system in which at least some operations described herein can be implemented

The technologies described herein will become more apparent to those skilled in the art from studying the Detailed Description in conjunction with the drawings. Embodiments or implementations describing aspects of the invention are illustrated by way of example, and the same references can indicate similar elements. While the drawings depict various implementations for the purpose of illustration, those skilled in the art will recognize that alternative implementations can be employed without departing from the principles of the present technologies. Accordingly, while specific implementations are shown in the drawings, the technology is amenable to various modifications.

### DETAILED DESCRIPTION

A content generation platform iteratively generates prompts into a generative model that instruct the generative model to generate a content item. A user can provide an initial topic for the content item, representing, for example, a broad subject or theme for the content item. Based on the initial topic, the content generation platform performs a search of an information source to identify a set of additional topics that are related to the initial topic. For example, the additional topics can break the initial topic down into more focused sub-topics or can address a concept that is related to a concept within the initial topic. A user can select any of these additional topics for refining the content item. The content generation platform can then repeat this process any desired number of times, performing a search for any of the additional topics that are selected by a user to identify still further related topics, until a detailed, rich set of topics are selected for the content item. The content generation platform generates one or more prompts into a generative model based on the user-selected topics. By iteratively generating prompts in this manner, the content generation platform automatically generates comprehensive and detailed content items that are specifically tailored to the subject matters or themes selected by a user.

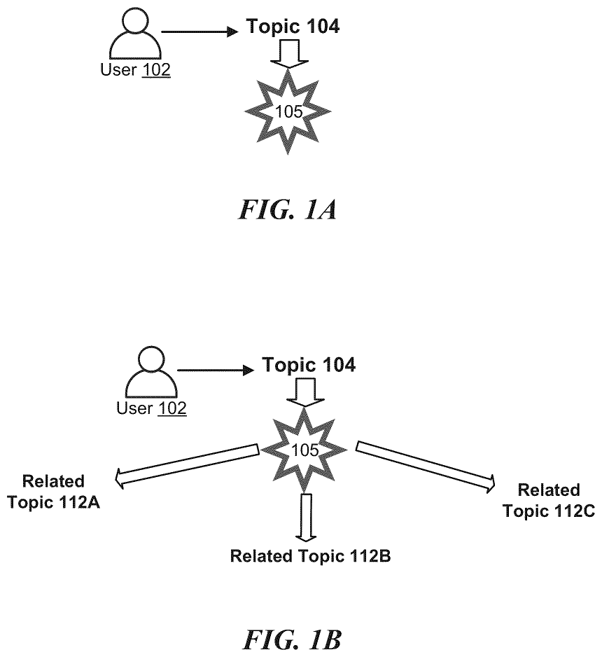

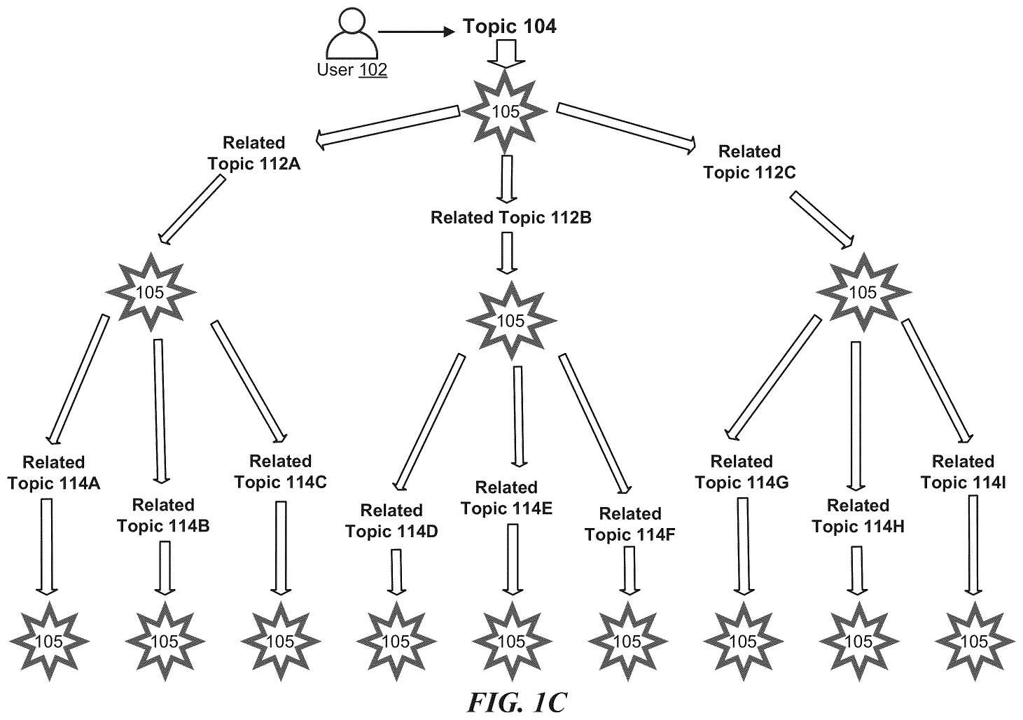

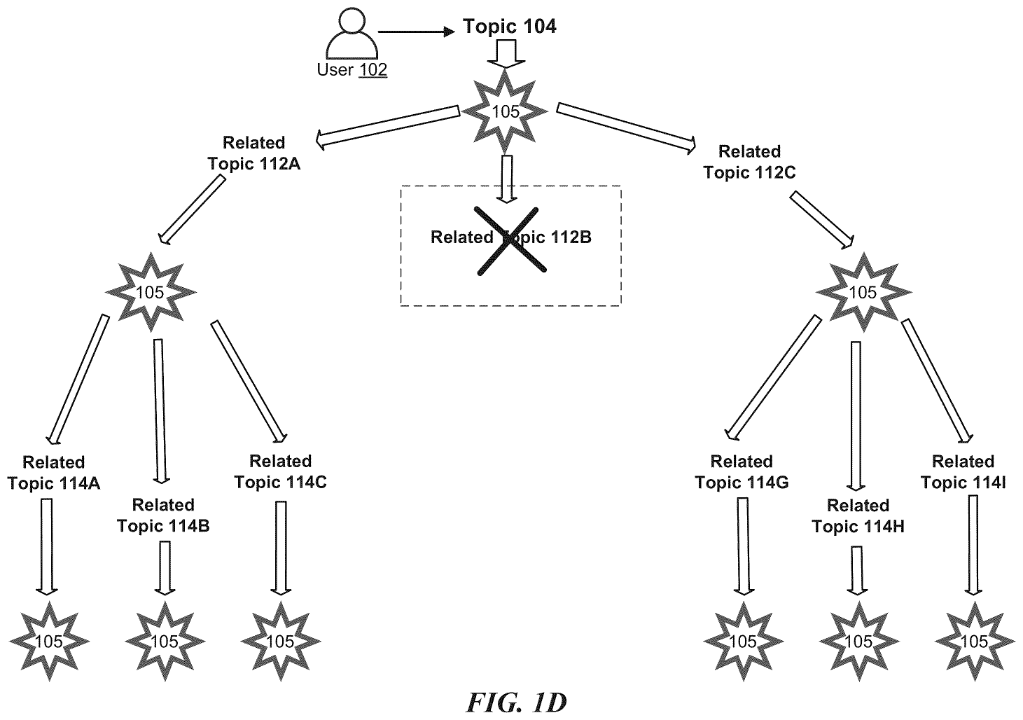

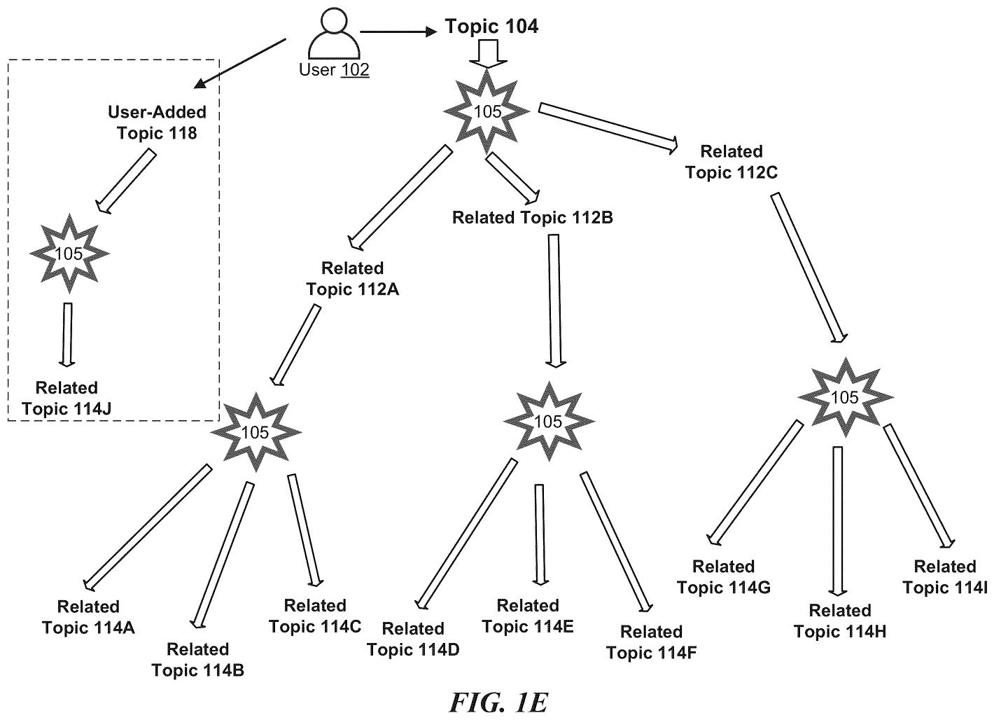

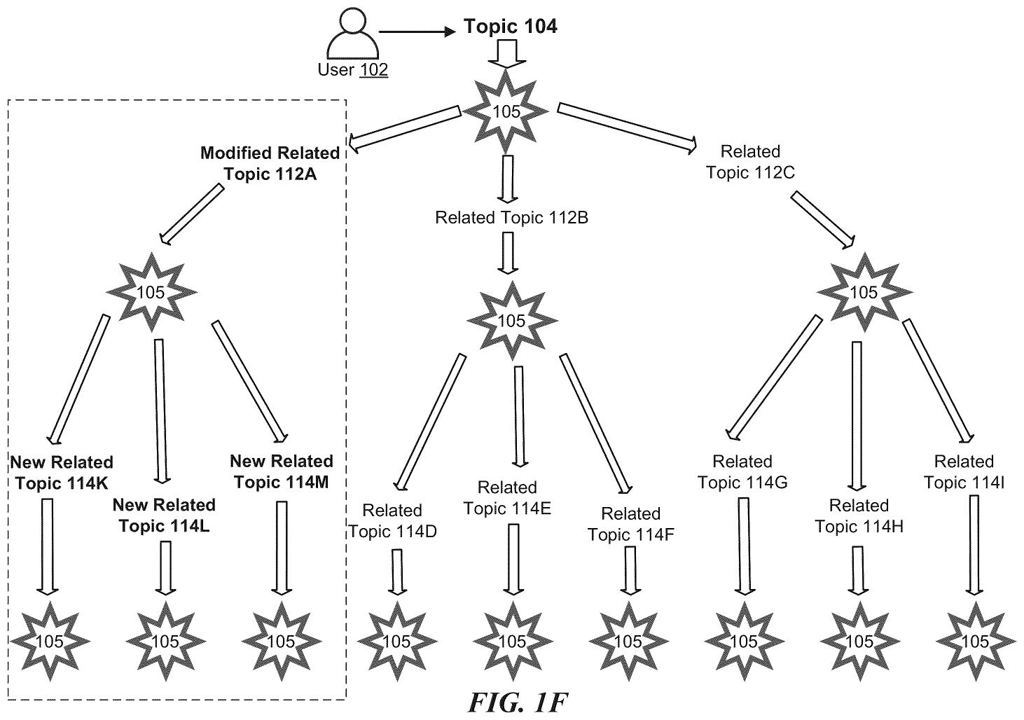

FIGS. 1A-1E are schematic diagrams illustrating an example process by which a content generation platform generates a content item, according to some implementations described herein. In general, the content generation platform dynamically generates a tree structure of topics for the content item. This tree structure is used to iteratively build a prompt that instructs a generative model, such as a large language model (LLM) or an image generation model, to generate the content item based on the topics in the resulting tree structure. The content generation platform can leverage generative models to automate generating any of a variety of types of content items, including text-based content items (such as stories or articles), image-based content items, video-based content items, or content items that include multimodal content.

As illustrated in FIG. 1A, a user 102 provides an initial instruction to generate a content item, where the initial instruction includes at least one topic 104 for the content item. In addition to the topic, the initial instruction can specify the type of content item to be generated, data to use for generating the content item, or attributes of the content item (such as tone, style, or length). In an example, the instruction received from the user 102 asks the content generation platform to “generate a story about the impact of Covid,” where “impact of Covid” is interpreted by the platform as the topic 104.

Using the initial instruction, the content generation platform performs a prompt refinement task 105. The prompt refinement task 105 includes a search of an information source using at least a portion of the topic 104 to identify a set of additional topics that are related to the topic 104. For example, the content generation platform can perform a general search of web content (e.g., using Google or another public search engine), a search of a particular content repository or type of content specified by the user, a search of a private content repository associated with an account of the user, or a search across multiple public or private data sources or content repositories.

The search performed by the content generation platform can be a semantic search identifying content in the searched dataset that is semantically related to at least a portion of the topic 104. Alternatively, the content generation platform can use a vector search by generating an embedding that represents the user instruction, the topic 104, or a synthesized set of related topics. The vector search identifies content in the searched dataset that is represented by embeddings with at least a threshold similarity to the generated embedding. Furthermore, some implementations of the content generation platform use both semantic and vector-based searches in the prompt refinement task 105. After performing the search of the dataset, the content generation platform analyzes a specified number of the top search results returned in response to the search to identify topics related to the user input. For example, the content generation platform performs topic extraction on the content of the top ten search results to identify any topic discussed in the top search results. The identified topics are ranked using a ranking algorithm, and a subset of the topics are selected, based on the ranking, as additional topics related to the original topic 104.

The additional topics identified by the search are output to the user as potential refinements of the user's initial topic 104. FIG. 1B illustrates a set of first-level related topics 112 identified by the prompt refinement task 105. Continuing the example above, in which the user input topic 104 is the “impact of Covid,” the first-level related topics 112 can include, for example, “Covid impact on global economy,” “Covid impact on mental health,” and “Covid impact on education.” The user can select all, some, or none of these topics for further refinement of the content item that is to be generated. In some implementations, the user can modify any of the related topics output by the content generation platform, add additional topics, or request that the content generation platform regenerate the topic suggestions.

The content generation platform can iterate the prompt refinement task 105 any desired number of times. For example, a user can select one or more of the first-level related topics 112 for further refinement. FIG. 1C illustrates an example in which each of the first-level related topics 112 is refined further via an additional prompt refinement task 105. The prompt refinement task 105 returns second-level related topics 114, which are additional topics related to each of the respective ones of the first-level related topics 112. Continuing the “impact of Covid” topic example, the second-level related topics 114A-C under the first-level related topic “Covid impact on global economy” can include, for example, “global GDP decline due to Covid,” “unemployment rate increase during Covid,” and “Covid impact on small businesses.” The second-level related topics 114D-F under the first-level related topic “Covid impact on mental health” can include, for example, “Covid-related anxiety statistics,” “depression rates during Covid pandemic,” and “Covid impact on therapy and counseling.” Finally, the second-level related topics 114G-1 under the first-level related topic “Covid impact on education” can include, for example, “remote learning statistics during Covid,” “Covid impacts on school dropout rates,” and “Covid effect on student performance.” For each of the second-level related topics 114, additional prompt refinement tasks 105 can then be performed to identify further related topics, and so on until a stopping condition is reached. The stopping condition can include, for example, a determination that a new level of related topics has a high degree of similarity to each other. Alternatively, the stopping condition can be a preconfigured number of iterations of the prompt refinement task 105 that are performed, an input from a user that ends the prompt refinement, or a lack of input from a user to continue prompt refinement.

The content generation platform synthesizes the topic 104 and any related topics 112, 114 (and additional levels, if applicable) into one or more prompts that instruct a generative model to generate a content item. Multiple levels of topics can be synthesized to provide additional context to the generative model. When a lower-level topic in the tree is selected for refining the generated content, the content generation platform can synthesize topics at higher levels in the tree to provide to the generative model along with the selected lower-level topic. In some implementations, the content generation platform generates a prompt before or while performing each prompt refinement task 105. For example, the content generation platform generates a first prompt based on the user-input topic 104. The first prompt can be sent to the generative model to cause the generative model to produce an initial content item, in parallel with the prompt refinement task 105. After the first prompt refinement task 105 in FIG. 1C that returns the first-level related topics 112, the content generation platform generates a second prompt that includes the first-level related topics 112. The second prompt can include both the user-input topic 104 and the first-level related topics 112 (e.g., by concatenating the four topics in a string). Alternatively, the second prompt can include only the first-level related topics 112 but specify further refinement on the first prompt (e.g., “Refine the story based on <topic 112A>, <topic 112B>, and <topic 112C>”). The second prompt can then be sent to the generative model to instruct the generative model to modify the initial content item. After the next iteration of prompt refinement tasks 105, the content generation platform generates a third prompt that includes the next set of second-level related topics 114 and sends the third prompt to the generative model, repeating for each iteration of the prompt refinement task 105. At each iteration, the content item generated by the generative model can be output to the user. Accordingly, the user can review the content item and determine whether additional prompt refinement is desired.

In other implementations, the content generation platform generates a single prompt that synthesizes any topics in the tree structure shown in FIG. 1C. For example, if a stopping condition occurs for iterations of the prompt refinement task 105 after the set of second-level related topics 114 is generated, the content generation platform synthesizes the second-level related topics 114, the first-level related topics 112, and the topic 104 into a single prompt that instructs the generative model to generate a content item based on the set of synthesized topics. Still other implementations of the content generation platform generate some prompts in parallel to or prior to performing some prompt refinement tasks 105, but combine topics generated from two or more other prompt refinement tasks 105 into the same prompt.

Users can interact with the content generation platform to modify the tree structure shown in FIG. 1C, for example to delete nodes, add nodes, or modify nodes.

FIG. 1D illustrates an example in which the user has removed the first-level related topic 112B from the tree. When generating prompts to the generative model, the content generation platform synthesizes the topic 104, the two remaining first-level related topics 112A and 112C, and the corresponding second-level related topics 114A-C and 114G-1.

FIG. 1E illustrates an example in which the user has added a new first-level topic 118. The user-added topic 118 can be synthesized in one or more prompts with the other first-level related topics 112. Furthermore, a prompt refinement task 105 can be completed based on the user-added topic 118, generating one or more second-level related topics (such as the second-level related topic 114J shown in FIG. 1D). These second-level related topics can also be synthesized in a prompt with higher-level topics in the tree.

Finally, FIG. 1F illustrates an example in which the user has modified the first-level related topic 112A, creating a modified related topic 112A. As before, the content generation platform can perform one or more iterations of the prompt refinement task 105 based on the modified related topic 112A, for example to produce new second-level related topics 114K, 114L, and 114M.

### Content Generation Platform Architecture

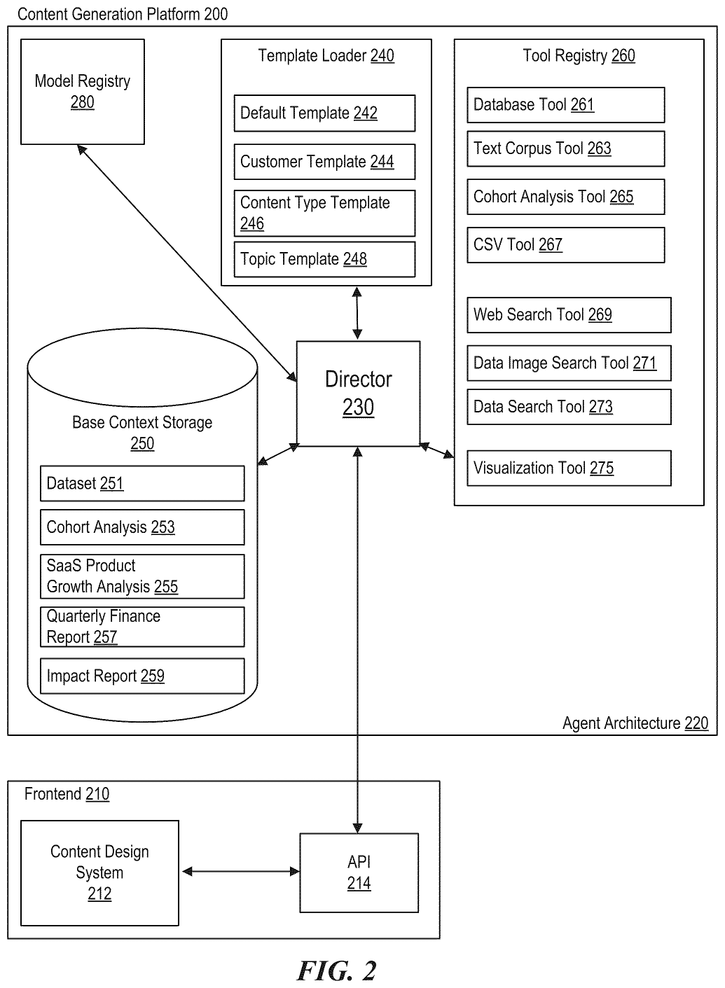

FIG. 2 is a block diagram illustrating an architecture of a content generation platform 200, according to some implementations. As shown in FIG. 2, the content generation platform 200 includes a frontend system 210 configured to communicate with components of an agent architecture 220.

The frontend 210 includes a content design system 212. The content design system 212 outputs user interfaces to a user (e.g., via a computing device used by the user) that display information to the user and receive inputs from the user.

An application programming interface (API) 214 interfaces between the content design system 212 and the agent architecture 220. The API 214 can authenticate a user who is accessing the content generation platform 200 and maintain a persistent user state during the user's interactions with the platform. As user inputs are received via the content design system 212, the API 214 can relay these inputs to the agent architecture 220. Similarly, the API 214 can mediate responses from the agent architecture 220 or a generative model to validate the responses from these systems, enforce permissions, and provide data to the content design system 212 for output to the user.

The agent architecture 220 can include a director 230, a template loader 240, a base context storage 250, a tool registry 260, and a generative model registry 280.

The director 230 handles communications to and from the frontend 210 and causes prompts to be sent to one or more generative models. When an instruction is received from the frontend 210 to generate a content item, the director 230 can perform searches to identify additional topics related to user-specified or selected topics. As user selections of topics are received from the frontend 210, the director 230 generates prompts into a generative model that instruct the model to generate a content item based on the selected topics. The director 230 can further coordinate interactions between the template loader 240, base context storage 250, and model registry 280 to provide templates or context to the generative model with the prompts, enabling the generative model to use the templates and context when generating the content items.

The template loader 240 maintains a set of content item templates. Content templates can be used to instruct the generative model to generate particular types of content and can include, for example, a default template 242, a customer-specific template 244, a type-specific template 246, and/or a topic-specific template 248. When a user input is received to generate content, the director 230 calls the template loader 240 to select a content template for the content to be generated. The content template can be selected based on content of the user input, based on an identity of the user, or based on other explicit or implicit criteria. For example, some users or organizations of users can upload customer-specific templates 244 that are used to generate content for the particular user or for users affiliated with the organization. When a request to generate a content item is received from a user, the template loader 240 can identify any customer templates 244 associated with the requesting user. In other cases, the template loader 240 identifies the type of content to generate by matching keywords from a user input to a content-type template 246 or topic template 248. For example, if a user instructs the platform 200 to “generate a story about . . . ” or “generate a report about . . . ,” the template loader 240 respectively selects “story” and “report” templates from a set of content type-specific templates 246. Similarly, if the user instruction requests a content item that will be based on the “effect of new feature launch on last quarter's SaaS revenue,” the template loader determines that the topic template “SaaS product growth analysis” should be used to generate content in response to the user input. The template loader 240 can use techniques other than keyword matching to identify matching content-type templates or topic templates, such as semantic analysis of user inputs, analysis of a history of content types generated by the user, or using an LLM to match a user's instruction to the closest content or topic template. Furthermore, the template loader 240 can return multiple templates for use in generating a content item, such as both a customer-specific template and a content-specific template. If no template applicable to the user's instruction is found—or upon explicit instruction by the user—the template loader 240 can provide the default template 242 for use in generating the content item.

The base context storage 250 maintains documents or data sets that provide context for a generative model to use when generating content items. The base context can include content blocks that represent discrete units of information such as text snippets, paragraphs, images, or other media types that the model can reference to generate new content. These content blocks can include generalized data or data that is specialized for a particular purpose. For example, as shown in FIG. 2, the base context storage 250 can store a dataset 251, which represents a set of raw or processed data generated by an organization or user of the platform 200. The storage 250 can also maintain a cohort analysis 253 that is performed based on the dataset 251 or based on other data. An organization can also upload or link specialized context that is used to generate the organization's content items. For example, an organization can provide a SaaS product growth analysis context 255 that is used to generate content items that describe the growth of the organization's SaaS products, a quarterly finance report 257 that is used to generate content items that include the organization's specific financial performance numbers, or an impact report 259 that is used to generate content items comparing the impact of an organization's initiatives. Any of a variety of other types of data or content can be maintained by or linked to the base context storage 250, such that the context can be used by a generative model as building blocks for generating new content items. In addition to the content blocks, the base context storage 250 can maintain success criteria that define parameters for evaluating quality and effectiveness of generated content, such as relevance, coherence, accuracy, or user satisfaction.

The tool registry 260 maintains a set of tools that can be used by the director 230 or by a generative model to perform functions related to generating content items. Some tools in the tool registry 260 can enable the director 230 or generative model to access, process, or generate certain data types, such as a database tool 261, a text corpus tool 263, a cohort analysis tool 265, or a comma-separated values (CSV) file tool 267. The tool registry 260 can further maintain tools that are used by the director 230 to perform searches of one or more data repositories, enabling the director 230 to identify sets of additional topics that are related to a user-input or user-selected topic. These search tools can include, for example, a web search tool 269 that performs a semantic web search for a topic, a data image search tool 271 that performs searches within a repository of images, and a data search tool 273 that performs searches within a dataset. Finally, the tool registry 260 can include a visualization tool 275 that enables the director 230 to generate visualizations that are displayed to a user, such as a visualization of a tree diagram of topics and related topics that are generated as the director iteratively refines prompts.

The model registry 280 maintains information about one or more generative models that can be used by the platform 200 to generate content items. In some implementations, the model registry 280 stores, for each generative model, a set of parameters that describe, for example, types of inputs accepted by the model, types of outputs that can be generated by the model, maximum input size or maximum data input rate parameters, pricing parameters, etc. When a request to generate a content item is received, the model registry 280 can use these parameters to select the generative model that is best suited for handling the request (e.g., the model that can produce the desired type of content item). Additionally or alternatively, the model registry 280 can select a generative model for handling a user's request based on user-specified information, such as user instructions to comply with a certain privacy policy or pricing constraints. The model registry 280 can additionally maintain a set of APIs for each generative model and can configure prompts into the generative models using these APIs.

### Generating Content Items

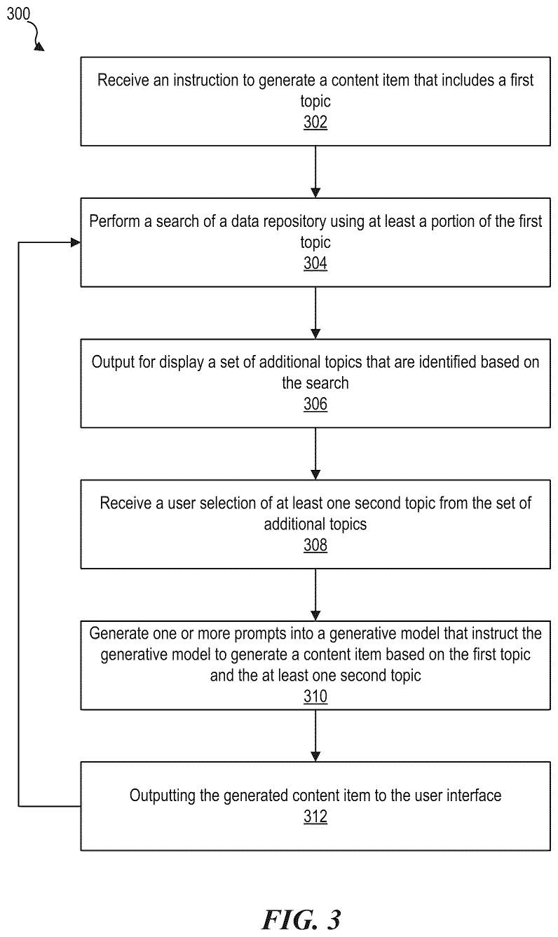

FIG. 3 is a flowchart illustrating a process 300 for iteratively generating prompts for content generation, according to some implementations. The process 300 can be performed by one or more computer systems, such as the content generation platform 200. Other implementations of the process 300 include additional, fewer, or different steps, or perform the steps in different orders.

At 302, the content generation platform 200 receives, via a user interface, an instruction to generate a content item. The instruction can include at least a first topic for the content item.

At 304, the content generation platform 200 performs a first search of an information source using at least a portion of the first topic. For example, the content generation platform 200 performs a semantic web search or a semantic or vector search of a specialized or private content repository. The first search identifies a first set of additional topics that are related to the first topic, which are output for display by the user interface at 306. The first set of additional topics can be output in various ways, such as displaying the additional topics in a tree diagram that visually relates the additional topics to the first topic, or outputting a list or set of selectable identifiers of the additional topics within a chat interface.

At 308, the content generation platform 200 receives a user selection of at least one second topic from the first set of additional topics.

Based on the first topic and the at least one second topic, the content generation platform 200 generates one or more prompts, at 310. The one or more prompts instruct a generative model to generate the content item based on the first topic and the at least one second topic and return the generated content item. The resulting content item can be output to the user interface for display to the user, at 312.

The content generation platform 200 can iteratively perform some or all steps of the process 300, progressively refining the prompts into the generative model. In some implementations, the content generation platform 200 generates a prompt after each user selection of a topic. For example, a first prompt is generated based on the first topic and used to instruct the generative model to generate a first draft of the content item. After the user reviews the first draft and selects a second topic from the first set of additional topics, the platform 200 generates a second prompt based on the second topic. The second prompt instructs the generative model to modify the first draft of the content item, producing a second draft. If the user continues refining the prompt by continuing to select sub-topics that are related to the second topic, the platform 200 can continue to iteratively generate prompts and to produce search results for additional related topics. In other implementations, the content generation platform 200 generates one or more prompts after the user has made any desired topic selections, where the one or more prompts instruct the generative model to generate a content item based on all of the selected topics.

### User Interfaces for Generating Content Items

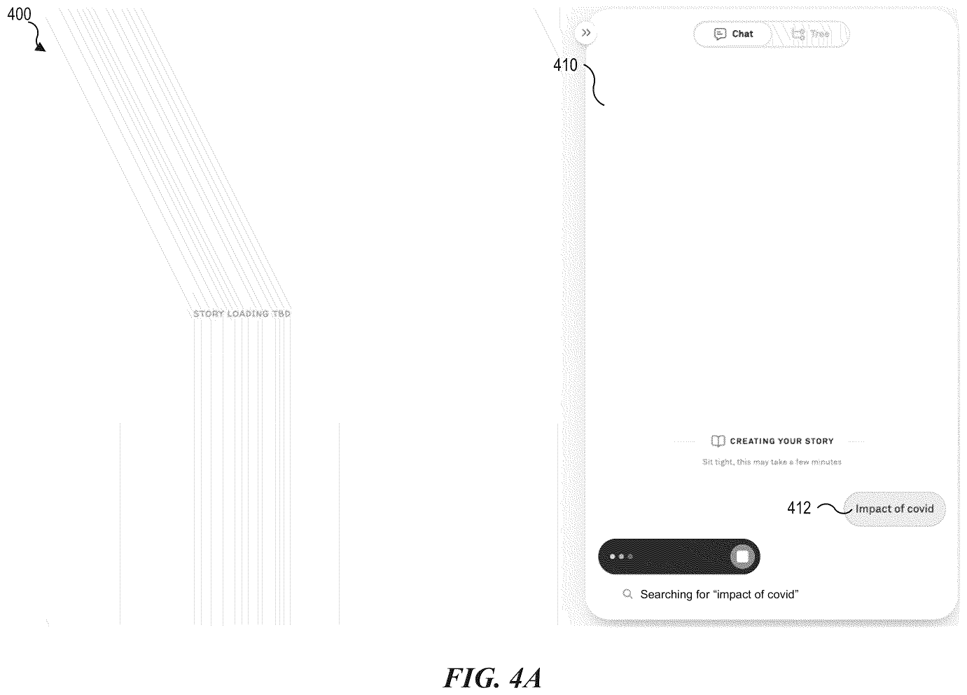

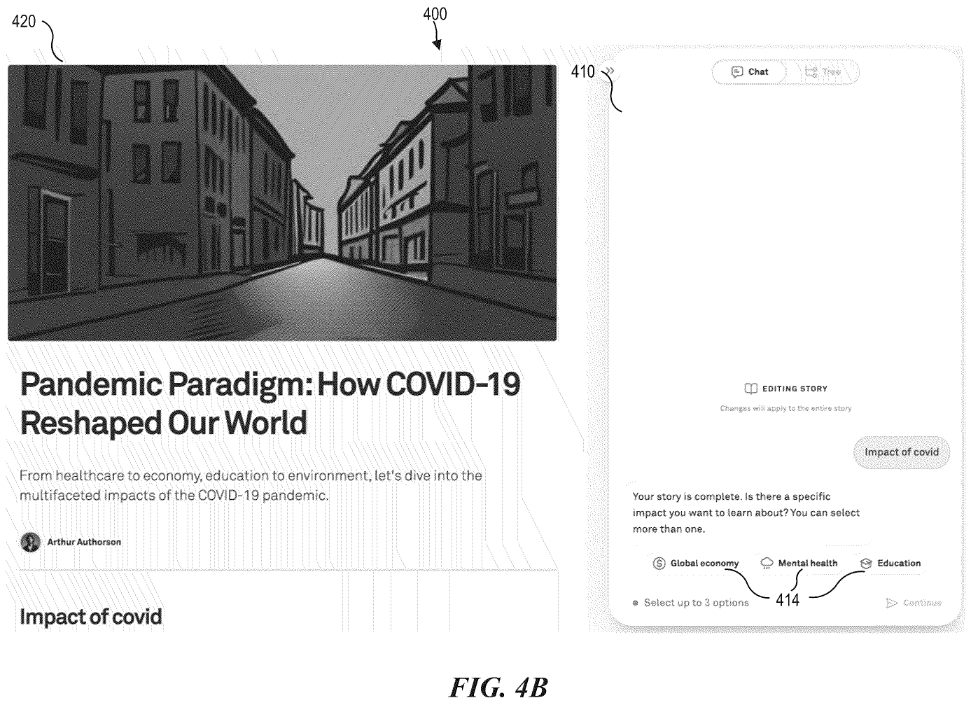

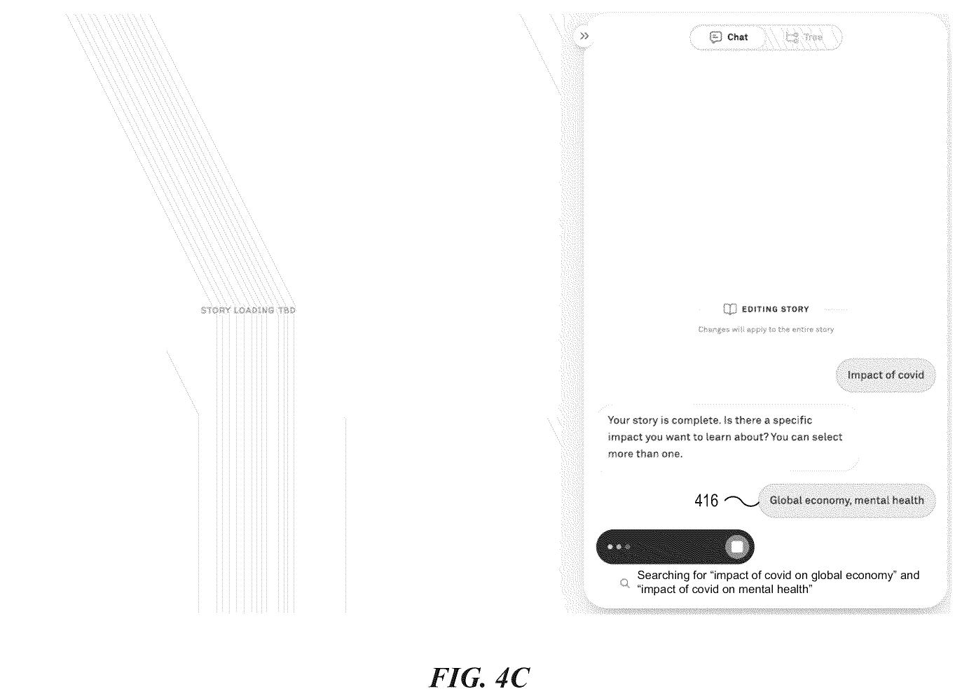

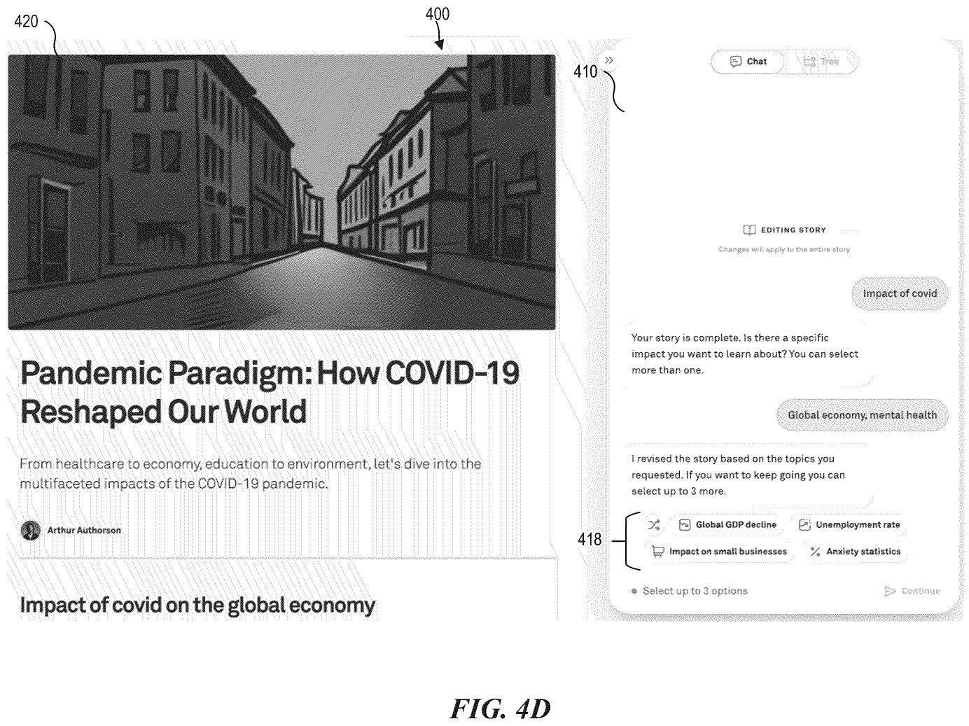

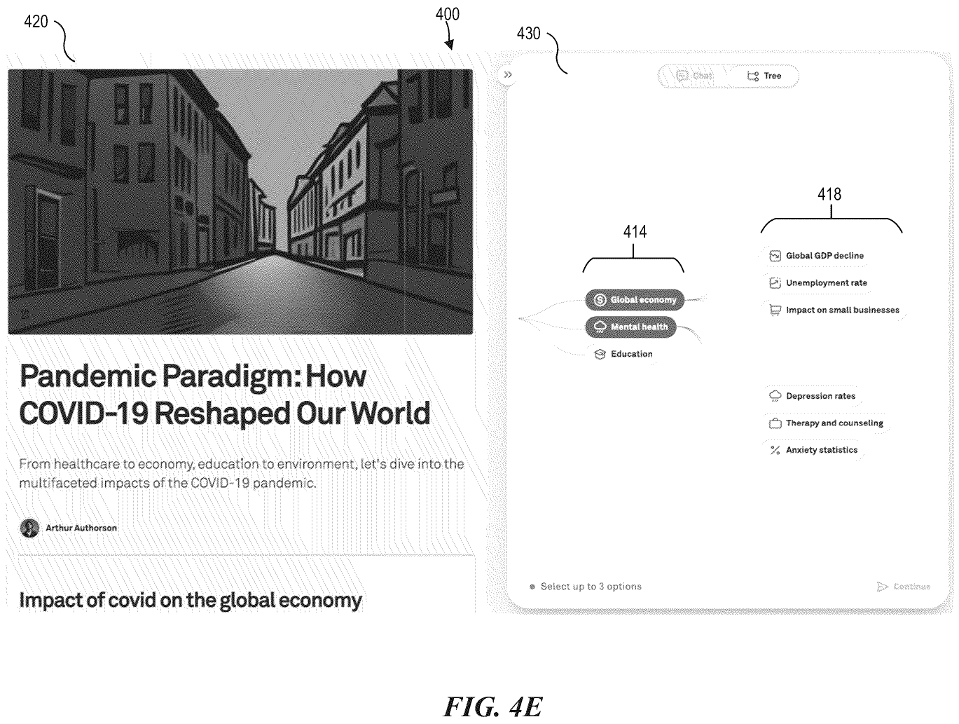

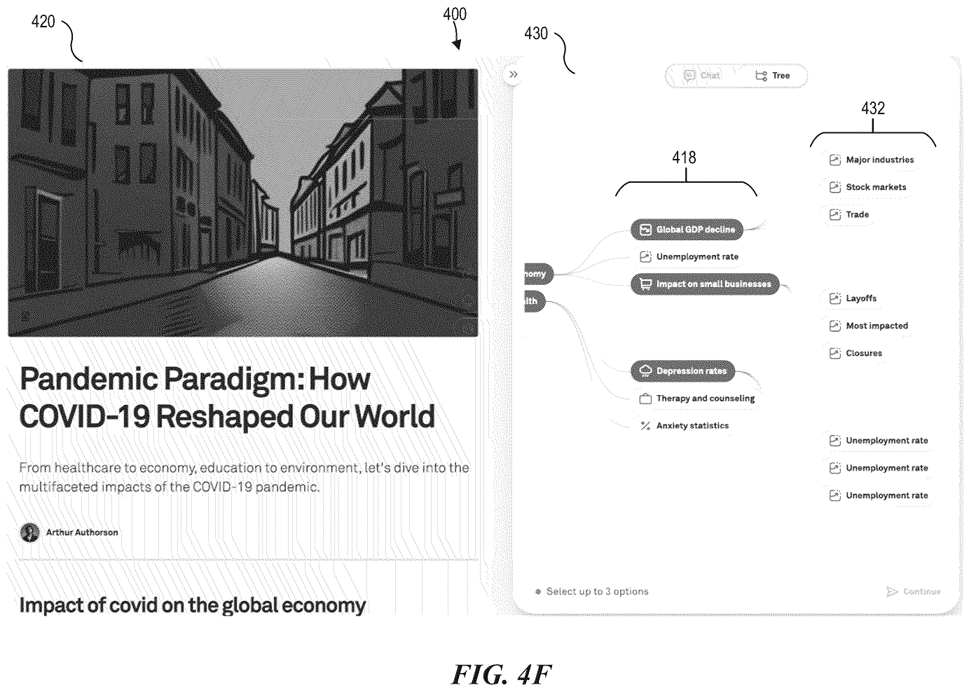

FIGS. 4A-4F illustrate example user interfaces that are output from the content generation platform 200 for display to a user and that facilitate content generation according to implementations herein. By way of example, FIGS. 4A-4F illustrate a process by which a user generates a story about the topic, “impact of Covid.”

FIG. 4A illustrates an example user interface 400 in which a user can interact with the content generation platform 200 via a chat window 410. In the chat window, the user can provide a natural language input 412 (such as “impact of covid”) that at least specifies a topic for the story that is to be created.

In FIG. 4B, the content generation platform 200 returns a set of additional topics 414 that are related to the user-provided topic. The additional topics 414 can be displayed within the chat window 410 as selectable options, enabling a user to select one or more of these topics 414 for further refinement of the story by interacting with the displayed selectable options (e.g., by tapping on or clicking on the displayed option). Alternatively, as shown in FIG. 4C, the user can input a natural language instruction 416 that specifies which of the additional topics 414 the user wants to use to refine the story. The user can instead provide a natural language input that specifies topics other than the additional topics generated by the content generation platform 200. Additionally, FIG. 4B illustrates an example implementation in which the content generation platform 200 generates a draft of the story in parallel to the prompt refinement task that returns the additional topics 414. The story draft can be displayed in a content viewing window 420 within the user interface 400. The user can therefore review the story in the content viewing window 420 to help determine whether further refinement of the story is desired and, if so, which of the additional topics 414 to select for refining the story.

FIG. 4D illustrates that the content generation platform 200 can suggest further options for refining a prompt. After the user selects topics from the first set of additional topics 414, the content generation can output a second set of additional topics 418 to the chat window 410. The platform 200 can also prompt the generative model to revise the draft story based on the user-selected additional topics, outputting the revised draft to the content viewing window 420 for the user to review while deciding whether to further refine the prompt based on any of the additional topics 418. This process—in which the content generation platform 200 performs a search for additional topics related to a user-input or user-selected topic, outputs the additional topics identified by the search, and regenerates the story based on the user's selections—can be repeated until the user indicates that the story is complete or until another stopping condition is reached.

A user can interact with the chat window 410 to add topics other than those output by the platform 200, modify the topics output by the platform 200, or remove topics that have previously been selected. For example, a user can add, modify, or remove topics by inputting a natural language instruction into the chat window 410. Alternatively, the user can interact with past inputs in the chat window 410, for example to deselect a topic that was previously selected during the chat interaction with the platform 200.

FIG. 4E illustrates another example user interface 400, in which a user interacts with the content generation platform 200 via a tree interface 430. Rather than the platform outputting the additional topics 414 and 418 within the context of a chat session, the tree interface 430 provides an iteratively generated tree diagram of topics and associated related topics as nodes in a tree. The tree diagram visually represents a relationship between each topic and any set of additional topics that are generated based on the topic, for example by depicting the topic and set of additional topics as nodes that are connected by branches in the tree. A user can interact with the nodes (e.g., by clicking or tapping on a node) to select a corresponding topic for further refinement of the prompt, causing the content generation platform 200 to perform a prompt refinement task that generates a next level of nodes. For example, in FIG. 4E, the user has selected the “global economy” and “mental health” topics from the first set of additional topics 414, which cause the content generation platform 200 to generate and output a second set of additional topics 418 associated with the two selected topics from the first set. FIG. 4F illustrates that this process can be iterated again to produce a third set of additional topics 432.

The tree interface 430 can be interactive to, for example, zoom in or out of the resulting tree diagram or to scroll from one part of the tree diagram to another, allowing the user to view different parts of potentially large trees. As the user makes each selection in the tree interface 430, the content generation platform 200 can correspondingly prompt the generative model to generate or update the story, which can be displayed in the content viewing window 420. Alternatively, the platform 200 can prompt the generative model to generate the story after any user selections have been received. Similarly, a user can interact with the tree interface 430 to add other topics, modify the topics in the tree, or delete topics from the tree.

### Computer System

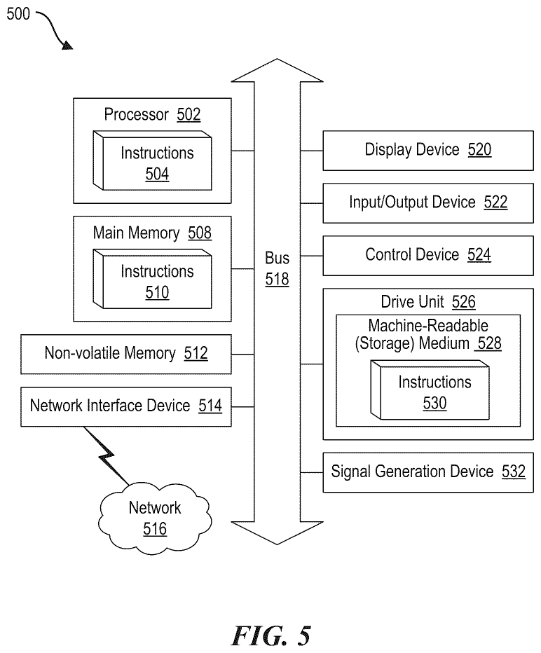

FIG. 5 is a block diagram that illustrates an example of a computer system 500 in which at least some operations described herein can be implemented. As shown, the computer system 500 can include: one or more processors 502, main memory 506, non-volatile memory 510, a network interface device 512, a video display device 518, an input/output device 520, a control device 522 (e.g., keyboard and pointing device), a drive unit 524 that includes a machine-readable (storage) medium 526, and a signal generation device 530 that are communicatively connected to a bus 516. The bus 516 represents one or more physical buses and/or point-to-point connections that are connected by appropriate bridges, adapters, or controllers. Various common components (e.g., cache memory) are omitted from FIG. 5 for brevity. Instead, the computer system 500 is intended to illustrate a hardware device on which components illustrated or described relative to the examples of the figures and any other components described in this specification can be implemented.

The computer system 500 can take any suitable physical form. For example, the computing system 500 can share a similar architecture as that of a server computer, personal computer (PC), tablet computer, mobile telephone, game console, music player, wearable electronic device, network-connected (“smart”) device (e.g., a television or home assistant device), AR/VR systems (e.g., head-mounted display), or any electronic device capable of executing a set of instructions that specify action(s) to be taken by the computing system 500. In some implementations, the computer system 500 can be an embedded computer system, a system-on-chip (SOC), a single-board computer system (SBC), or a distributed system such as a mesh of computer systems, or it can include one or more cloud components in one or more networks. Where appropriate, one or more computer systems 500 can perform operations in real time, in near real time, or in batch mode.

The network interface device 512 enables the computing system 500 to mediate data in a network 514 with an entity that is external to the computing system 500 through any communication protocol supported by the computing system 500 and the external entity. Examples of the network interface device 512 include a network adapter card, a wireless network interface card, a router, an access point, a wireless router, a switch, a multilayer switch, a protocol converter, a gateway, a bridge, a bridge router, a hub, a digital media receiver, and/or a repeater, as well as all wireless elements noted herein.

The memory (e.g., main memory 506, non-volatile memory 510, machine-readable medium 526) can be local, remote, or distributed. Although shown as a single medium, the machine-readable medium 526 can include multiple media (e.g., a centralized/distributed database and/or associated caches and servers) that store one or more sets of instructions 528. The machine-readable medium 526 can include any medium that is capable of storing, encoding, or carrying a set of instructions for execution by the computing system 500. The machine-readable medium 526 can be non-transitory or comprise a non-transitory device. In this context, a non-transitory storage medium can include a device that is tangible, meaning that the device has a concrete physical form, although the device can change its physical state. Thus, for example, non-transitory refers to a device remaining tangible despite this change in state.

Although implementations have been described in the context of fully functioning computing devices, the various examples are capable of being distributed as a program product in a variety of forms. Examples of machine-readable storage media, machine-readable media, or computer-readable media include recordable-type media such as volatile and non-volatile memory 510, removable flash memory, hard disk drives, optical disks, and transmission-type media such as digital and analog communication links.

In general, the routines executed to implement examples herein can be implemented as part of an operating system or a specific application, component, program, object, module, or sequence of instructions (collectively referred to as “computer programs”). The computer programs typically comprise one or more instructions (e.g., instructions 504, 508, 528) set at various times in various memory and storage devices in computing device(s). When read and executed by the processor 502, the instruction(s) cause the computing system 500 to perform operations to execute elements involving the various aspects of the disclosure.

### Remarks

The terms “example,” “embodiment,” and “implementation” are used interchangeably. For example, references to “one example” or “an example” in the disclosure can be, but not necessarily are, references to the same implementation; and such references mean at least one of the implementations. The appearances of the phrase “in one example” are not necessarily all referring to the same example, nor are separate or alternative examples mutually exclusive of other examples. A feature, structure, or characteristic described in connection with an example can be included in another example of the disclosure. Moreover, various features are described that can be exhibited by some examples and not by others. Similarly, various requirements are described that can be requirements for some examples but not for other examples.

The terminology used herein should be interpreted in its broadest reasonable manner, even though it is being used in conjunction with certain specific examples of the invention. The terms used in the disclosure generally have their ordinary meanings in the relevant technical art, within the context of the disclosure, and in the specific context where each term is used. A recital of alternative language or synonyms does not exclude the use of other synonyms. Special significance should not be placed upon whether or not a term is elaborated or discussed herein. The use of highlighting has no influence on the scope and meaning of a term. Further, it will be appreciated that the same thing can be said in more than one way.

Unless the context clearly requires otherwise, throughout the description and the claims, the words “comprise,” “comprising,” and the like are to be construed in an inclusive sense, as opposed to an exclusive or exhaustive sense—that is to say, in the sense of “including, but not limited to.” As used herein, the terms “connected,” “coupled,” and any variants thereof mean any connection or coupling, either direct or indirect, between two or more elements; the coupling or connection between the elements can be physical, logical, or a combination thereof. Additionally, the words “herein,” “above,” “below,” and words of similar import can refer to this application as a whole and not to any particular portions of this application. Where context permits, words in the above Detailed Description using the singular or plural number may also include the plural or singular number, respectively. The word “or” in reference to a list of two or more items covers all of the following interpretations of the word: any of the items in the list, all of the items in the list, and any combination of the items in the list. The term “module” refers broadly to software components, firmware components, and/or hardware components.

While specific examples of technology are described above for illustrative purposes, various equivalent modifications are possible within the scope of the invention, as those skilled in the relevant art will recognize. For example, while processes or blocks are presented in a given order, alternative implementations can perform routines having steps, or employ systems having blocks, in a different order, and some processes or blocks may be deleted, moved, added, subdivided, combined, and/or modified to provide alternative or sub-combinations. Each of these processes or blocks can be implemented in a variety of different ways. Also, while processes or blocks are at times shown as being performed in series, these processes or blocks can instead be performed or implemented in parallel, or can be performed at different times. Further, any specific numbers noted herein are only examples such that alternative implementations can employ differing values or ranges.

Details of the disclosed implementations can vary considerably in specific implementations while still being encompassed by the disclosed teachings. As noted above, particular terminology used when describing features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed herein, unless the above Detailed Description explicitly defines such terms. Accordingly, the actual scope of the invention encompasses not only the disclosed examples but also all equivalent ways of practicing or implementing the invention under the claims. Some alternative implementations can include additional elements to those implementations described above or include fewer elements.

Any patents and applications and other references noted above, and any that may be listed in accompanying filing papers, are incorporated herein by reference in their entireties, except for any subject matter disclaimers or disavowals, and except to the extent that the incorporated material is inconsistent with the express disclosure herein, in which case the language in this disclosure controls. Aspects of the invention can be modified to employ the systems, functions, and concepts of the various references described above to provide yet further implementations of the invention.

To reduce the number of claims, certain implementations are presented below in certain claim forms, but the applicant contemplates various aspects of an invention in other forms. For example, aspects of a claim can be recited in a means-plus-function form or in other forms, such as being embodied in a computer-readable medium. A claim intended to be interpreted as a means-plus-function claim will use the words “means for.” However, the use of the term “for” in any other context is not intended to invoke a similar interpretation. The applicant reserves the right to pursue such additional claim forms either in this application or in a continuing application.

We claim:

1. A method comprising:
receiving at a computer system, via a user interface, an instruction to generate a content item, wherein the instruction includes a first topic for the content item;
iteratively generating, by the computer system, one or more prompts into a generative model based on the instruction by:
performing a first search of an information source using at least a portion of the first topic, wherein the first search identifies a first set of additional topics related to the first topic using the information source;
outputting the first set of additional topics for display by the user interface;
receiving a user selection, via the user interface, of at least one second topic selected from the first set of additional topics; and
generating the one or more prompts based on at least the first topic and the at least one second topic;
wherein the one or more prompts instruct the generative model to generate the content item based on the first topic and the at least one second topic and return the generated content item; and
outputting the generated content item to the user interface.

2. The method of claim 1, wherein generating the one or more prompts comprises:
generating a first prompt that includes the first topic;
sending the first prompt to the generative model to cause the generative model to generate a first draft of the generated content item;
outputting the first draft of the generated content item to the user interface;
after outputting the first draft of the generated content item, receiving the user selection of the at least one second topic; and
generating a second prompt that includes the at least one second topic and that instructs the generative model to modify the first draft of the generated content item based on the at least one second topic to produce a second draft of the generated content item.

3. The method of claim 2, further comprising:
outputting the second draft of the generated content item to the user interface;
performing a second search of the information source using at least a portion of the second topic, wherein the second search identifies a second set of additional topics related to the second topic;
outputting the second set of additional topics for display by the user interface;
receiving a user selection, via the user interface, of at least one third topic selected from the second set of additional topics;
generating a third prompt that includes the at least one third topic and that instructs the generative model to modify the second draft of the generated content item based on the at least one third topic.

4. The method of claim 2, further comprising:
outputting the second draft of the generated content item to the user interface;
receiving a user input to deselect the second topic; and
generating a third prompt that instructs the generative model to modify the second draft of the generated content item based on the deselection of the second topic.

5. The method of claim 1, wherein generating the one or more prompts comprises:
generating a first prompt that includes the first topic and the at least one second topic; and
sending the first prompt to the generative model to cause the generative model to generate the content item based on the first prompt.

6. The method of claim 1, wherein the instruction to generate the content item is received at a chat window of the user interface, and wherein outputting the first set of additional topics for display by the user interface comprises:
displaying, for each of additional topics in the first set of additional topics, a selectable option in the chat window;
wherein receiving the user selection of the at least one second topic comprises receiving a user input at the selectable option in the chat window that corresponds to the second topic.

7. The method of claim 1, wherein outputting the first set of additional topics for display by the user interface comprises:
generating for display by the user interface, a tree diagram that includes a plurality of nodes,
wherein a first in the plurality of nodes corresponds to the first topic and a set of second nodes correspond respectively to the additional topics in the first set of additional topics; and
wherein the tree diagram visually represents a relationship between the first topic and the first set of additional topics;
wherein receiving the user selection of the at least one second topic comprises receiving a user input at one of the set of second nodes in the tree diagram.

8. The method of claim 1, further comprising:
receiving, at the user interface, another instruction including a third topic for the content item;
performing a second search of the information source using at least a portion of the third topic, wherein the second search identifies a second set of additional topics related to the third topic; and
receiving a user selection, via the user interface, of at least one fourth topic selected from the second set of additional topics;
wherein generating the one or more prompts comprises generating the one or more prompts further based on the third topic and the at least one fourth topic.

9. The method of claim 1, wherein generating the one or more prompts comprises generating at least a first prompt based on the second topic, and wherein the method further comprises:
after generating the first prompt, receiving a user input modifying the second topic; and
generating a second prompt based on the modified second topic, wherein the second prompt instructs the generative model to modify the content item based on the modified second topic.

10. The method of claim 1, further comprising:
accessing a template for the content item based on the instruction to generate the content item;
wherein generating the one or more prompts further comprises generating one or more prompts that instruct the generative model to generate the content item using the accessed template.

11. The method of claim 1, wherein performing the search of the information source comprises performing a semantic search based on the first topic.

12. A non-transitory computer-readable storage medium storing executable instructions, the instructions when executed by one or more processors of a system causing the system to perform steps comprising:
generating one or more prompts into a generative model that instruct the generative model to generate at least a portion of a content item, wherein generating the one or more prompts comprises:
performing a first search of an information source using at least a portion of a first topic, wherein the first search identifies a first set of additional topics related to the first topic;
outputting the first set of additional topics for display by a user interface;
receiving a user selection, via the user interface, that identifies at least one second topic selected from the first set of additional topics; and
generating the one or more prompts based on at least the first topic and the at least one second topic and
outputting the generated content item to the user interface.

13. The non-transitory computer-readable storage medium of claim 12, wherein generating the one or more prompts comprises:
generating a first prompt that includes the first topic;
sending the first prompt to the generative model to cause the generative model to generate a first draft of the generated content item;
outputting the first draft of the generated content item to the user interface;
after outputting the first draft of the generated content item, receiving the user selection that identifies the at least one second topic; and
generating a second prompt that includes the at least one second topic and that instructs the generative model to modify the first draft of the generated content item based on the at least one second topic to produce a second draft of the generated content item.

14. The non-transitory computer-readable storage medium of claim 12, wherein generating the one or more prompts comprises:
generating a first prompt that includes the first topic and the at least one second topic; and
sending the first prompt to the generative model to cause the generative model to generate the content item based on the first prompt.

15. The non-transitory computer-readable storage medium of claim 12, wherein the instructions when executed further cause the system to:
receive, at a chat window of the user interface, a user instruction to generate the content item;
wherein outputting the first set of additional topics for display by the user interface comprises:
displaying, for each of additional topics in the first set of additional topics, a selectable option in the chat window;
wherein receiving the user selection of the at least one second topic comprises receiving a user input at the selectable option in the chat window that corresponds to the second topic.

16. The non-transitory computer-readable storage medium of claim 12, wherein outputting the first set of additional topics for display by the user interface comprises:
generating for display by the user interface, a tree diagram that includes a plurality of nodes,
wherein a first in the plurality of nodes corresponds to the first topic and a set of second nodes correspond respectively to the additional topics in the first set of additional topics; and
wherein the tree diagram visually represents a relationship between the first topic and the first set of additional topics;
wherein receiving the user selection of the at least one second topic comprises receiving a user input at one of the set of second nodes in the tree diagram.

17. A system comprising:
one or more processors; and
one or more non-transitory computer-readable storage media storing executable instructions, the instructions when executed by the one or more processors causing the system to perform steps comprising:
generating one or more prompts into a generative model that instruct the generative model to generate a content item, wherein generating the one or more prompts comprises:
receiving a user input identifying a first topic;
performing a first search of an information source using at least a portion of the first topic, wherein the first search returns a first set of additional topics related to the first topic;
outputting the first set of additional topics for display by the user interface;
receiving a user selection that identifies at least one second topic selected from the first set of additional topics; and
generating the one or more prompts based on at least the first topic and the at least one second topic; and
outputting the generated content item to the user interface.

18. The system of claim 17, wherein generating the one or more prompts comprises:
generating a first prompt that includes the first topic;
sending the first prompt to the generative model to cause the generative model to generate a first draft of the generated content item;
outputting the first draft of the generated content item to the user interface;
after outputting the first draft of the generated content item, receiving the user selection of the at least one second topic; and
generating a second prompt that includes the at least one second topic and that instructs the generative model to modify the first draft of the generated content item based on the at least one second topic to produce a second draft of the generated content item.

19. The system of claim 17, wherein generating the one or more prompts comprises:
generating a first prompt that includes the first topic and the at least one second topic; and
sending the first prompt to the generative model to cause the generative model to generate the content item based on the first prompt.

20. The system of claim 17, wherein outputting the first set of additional topics for display by the user interface comprises:
generating for display by the user interface, a tree diagram that includes a plurality of nodes,
wherein a first in the plurality of nodes corresponds to the first topic and a set of second nodes correspond respectively to the additional topics in the first set of additional topics; and
wherein the tree diagram visually represents a relationship between the first topic and the first set of additional topics;
wherein receiving the user selection of the at least one second topic comprises receiving a user input at one of the set of second nodes in the tree diagram.
